(19) United States
(12) Patent Application Publication
(10) Pub. No.: US 2014/0288999 A1
(43) Pub. Date: Sep. 25, 2014

(54) SOCIAL CHARACTER RECOGNITION (SCR) SYSTEM

(71) Applicant: CORRELOR TECHNOLOGIES LTD, Jerusalem (IL)

(72) Inventors: Orly OVADIA AMSALEM, Jerusalem (IL); Ronen TAL-BOTZER, Givatayim (IL)

(21) Appl. No.: 14/205,581

(22) Filed: Mar. 12, 2014

Related U.S. Application Data
(60) Provisional application No. 61/776,854, filed on Mar. 12, 2013.

(51) Int. Cl. G06Q 50/00; G06Q 30/02

(52) U.S. Cl. CPC G06Q 50/01; G06Q 30/0269; G06Q 30/0201
USPC 705/7.29; 705/319; 705/14.66

(57) ABSTRACT

A social character recognition system includes a user profile constructer and a data analyzer. The user profile constructer generates a user profile from user's social information available on the internet and from other external information, the user profile having multiple scales, where the lowest scale includes the raw data, higher scales aggregate the data into generic attributes and the topmost level defines a social character of the user. The data analyzer calculates similarities at least between a first user profile and a second user profile based on weighted functions of distances between the each of the scales in the user profiles.

### CROSS REFERENCE TO RELATED APPLICATIONS

This application claims priority to U.S. Provisional Application 61/776,854, filed Mar. 12, 2013, which application is incorporated in its entirety herein.

### FIELD OF THE INVENTION

The present invention relates to social data analysis generally and to a system and a method for predicting patterns in social data in particular.

### BACKGROUND OF THE INVENTION

Social data analysis has rapidly become a growing field as the Internet reaches into almost every household and social networks such as Facebook, Tweeter, among others, continue to grow in popularity. Social data analysis generally includes gathering information about people over the Internet by monitoring their social character as expressed through the social networks. This social character may provide an insight into a person's personality, which may be reflected, for example, by the person's preferences towards essentially anything with which the person may come into interaction. These may include, for example, food, travel, literature, hobbies, music, art, friends, and movies, among many others. The personality may also be reflected by expressions of what the person likes and dislikes. This information may then be used by entities to promote web-user directed product sales over the Internet as well as other web-based services, such as content recommendation and personalization in general.

### SUMMARY OF THE INVENTION

A social character recognition system includes a user profile constructer and a data analyzer. The user profile constructer generates a user profile from user's social information available on the internet and from other external information, the user profile having multiple scales, where the lowest scale includes the raw data, higher scales aggregate the data into generic attributes and the topmost level defines a social character of the user. The data analyzer calculates similarities at least between a first user profile and a second user profile based on weighted functions of distances between the each of the scales in the user profiles.

Further, in accordance with a preferred embodiment of the present invention, the user profile constructer includes a data retriever to retrieve user social information from a user's social networks and other databases which describe a user's interests and actions, wherein the user social information includes at least one of: demographics, media items the user shared or ‘Liked’, posted texts and photos, groups to which s/he belongs, events s/he went to, places in the world s/he visited or ‘checked-in’, schools s/he attended, relationships dynamics with their friends, and activity properties in social networks.

Moreover, in accordance with a preferred embodiment of the present invention, wherein the lowest scale has an associated strongest weight.

Additionally, in accordance with a preferred embodiment of the present invention, the system also includes a website client to provide a user profile of a user who shows an interest in a product to the product thereby to pass the user profile of the user to the product.

Further, in accordance with a preferred embodiment of the present invention, the system also includes a user pattern discoverer to define a plurality of user social characters based on a multiplicity of user profiles. The data analyzer can include a social character updater to update a new user profile with a social character given to a user profile found to be similar to the new user profile.

Moreover, in accordance with a preferred embodiment of the present invention, the user profile is at least one of: invariant to noise, sensitive to nuances and encapsulates a user's personality traits on many levels.

Still further, in accordance with a preferred embodiment of the present invention, the system also includes an infection engine to infect items sold by a company with a user profile of a user who interacted with the items thereby to provide the items with profiles.

Moreover, in accordance with a preferred embodiment of the present invention, the system also includes a recommendation engine to recommend items to a user based on the similarity of the user's profile with an item's profile.

Moreover, in accordance with a preferred embodiment of the present invention, the invention also includes a method to implement the functions of the system.

### BRIEF DESCRIPTION OF THE DRAWINGS

The subject matter regarded as the invention is particularly pointed out and distinctly claimed in the concluding portion of the specification. The invention, however, both as to organization and method of operation, together with information items, features, and advantages thereof, may best be understood by reference to the following detailed description when read with the accompanying drawings in which:

FIG. 1 schematically illustrates a SCR system according to an embodiment of the present invention;

FIG. 2 schematically illustrates a use case the SCR system of FIG. 1;

FIG. 3 schematically illustrates an infection process to create an item profile based on users' profiles;

FIG. 4 schematically illustrates the construction of a User Profile Space from different data sources (i.e. social networks, customer data, content databases), useful in the system of FIG. 1;

FIG. 5 schematically illustrates an example of a user profile space; and

FIG. 6 schematically illustrates the details of a Data Analyzer Module, useful in the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that social data may be represented by mathematical and statistical models, and can be interpreted and analyzed by known data mining and machine learning methods. Furthermore, applicants have further realized that the results of these analyses may be used to profile a person according to personality characterizations, for example, as being “geeky”, “glam”, “humorous”, “outsy”, “trendy”, “romantic”, “explorer”, “agreeable”, among many other types of characterizations. The person may also be profiled with more than one personality characterization, for example, “geeky” and “humorous”.

According to an embodiment of the present invention, applicants have devised a Social Character Recognition (SCR) system which constructs mathematical models from social data and other data and analyzes the models using data mining and machine learning algorithms. The SCR system further determines a person's profile which may include one or more personality characterizations and how strongly these characterizations are expressed based on the collected social data and the social character of the person.

Applicants have additionally realized that personality characterizations may be useful to classify and group together people having similar profiles. This may be potentially advantageous for applications which may require targeting particular groups of people and/or individual people within the groups. An example application may be for web-based services which seek to offer products and services to web users based on a person's specific interests and needs. Using an SCR system according to the present invention, web-based services may assess a person's interests and needs based on previously acquired data of the interests and needs of individual people and groups of peoples having a similar profile.

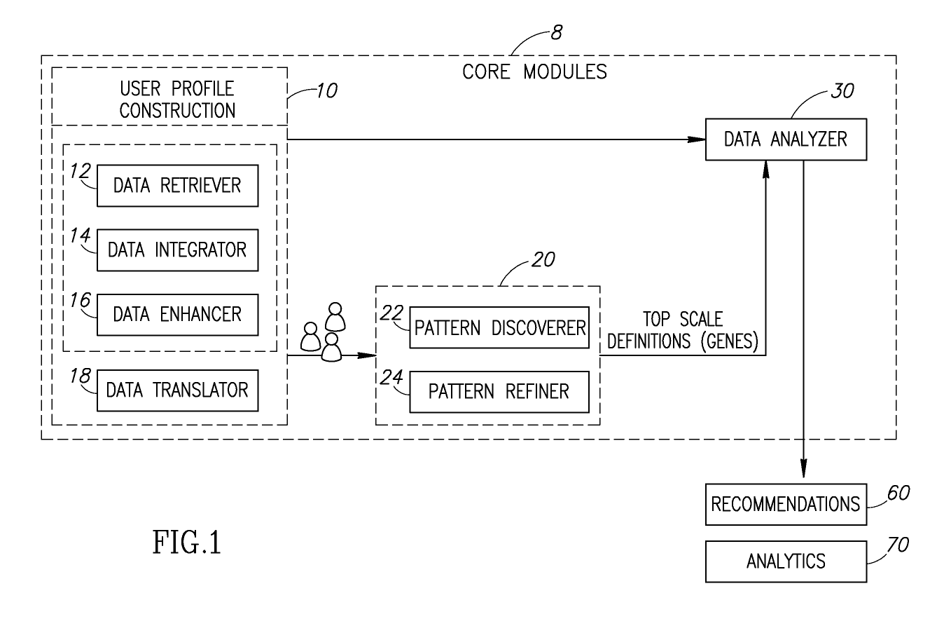

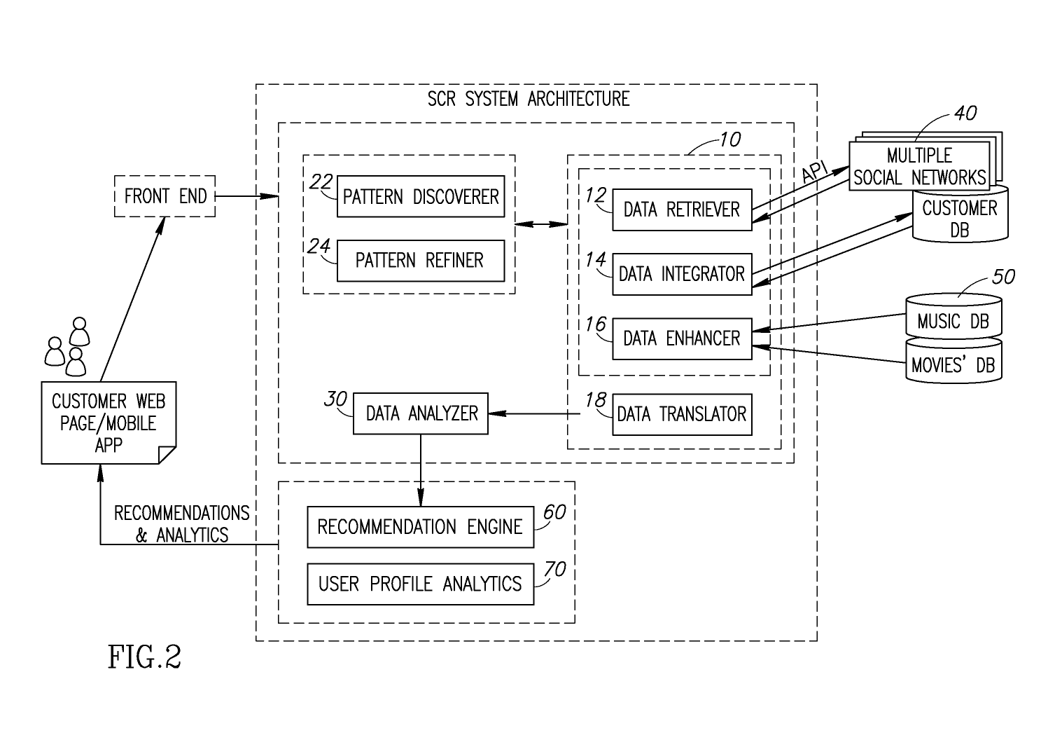

Reference is now made to FIG. 1 and FIG. 2 which schematically illustrate a SCR system according to an embodiment of the present invention and a use case of the system, respectively. The SCR system 8 may comprise a user profile constructer 10, a user pattern definer 20 and a data analyzer 30. User profile constructer 10 may comprise a social data retriever module 12, a data integrator module 14, a data enhancer module 16 and a data translator module 18. User pattern definer 20 may comprise a pattern discoverer module 22 and a pattern refiner module 24. In embodiments of the present invention, the SCR system may integrate one or more computing devices, including server devices and other communication device for communicating over communication networks including the Internet, databases for data collection and for storing processed data, and other suitable computing devices and computer-related devices including peripheral devices, for performing the SCR system functions.

Generating a User Profile Space

User profile constructer 10 may generate a User Profile Space (USP). This profile is a mathematical representation of the data collected from the social networks and other external data sources that might be available. As shown in FIG. 2, to generate the user profile, user profile constructer 10 may take the raw data from the different data sources 40 and may then interpret and arrange the data in a generic representation, so it can be used for further analysis. The novelty in the generation of the user profile lays in the methodology the profile is constructed. We present the concept of User Profile Space.

The User Profile Space is constructed by taking the raw data and “spanning” this data and its interpretations in various scales. Each scale gives a different “point of view” or “zoom-level” of the user's personality, characteristics and interests. At the top of the User Profile Space, the data is aggregated and the profile reflects the user character in a generic and agglomerative sense. As we go down the space, the profile is continuously expanded, so that the raw data itself is at the bottom-most layer of the space. This space defines a user profile descriptor which may represent a user's personality in a unique way, taking into account both the specific traits in the user's personality as well as generic attributes.

Social Data Retriever Module

The social data retriever module 12 retrieves raw social data from arbitrary users' profiles on social networks 40 using publicly available on-line APIs (application programming interfaces) for retrieving social data. These users may be an arbitrary sample of users, or users of a specific website. As shown in FIG. 2, such data may be their demographics, media items (such as music, movies, books, etc.) they shared or stated they ‘Liked’, texts and photos they posted, groups they belong to, events they went to, places in the world they visited or ‘checked-in’, schools they attended, relationships dynamics with their friends (correspondence volumes and frequency, ‘Liking’ each other's posts, mutual friends etc.), activity properties in the social networks (average number of posts per month, time of the day, browsing source—desktop vs. mobile, etc.). All of the above may be gathered in respect to the individual user or in respect to his friends and/or group participants and/or event participants, etc. In this way the information about the individual will be derived also from the information about other individuals, who share similar properties with him, whether they are his friends, group participants and so on. The signals collected by the Data Retriever module 12 lie at the bottom of the User-Profile-Space and establish a scale 0 of the User Profile Space together with the data collected from other data sources (such the customer databases) by the Data Integrator Module 14.

Data Integrator Module

The data integrator module 14 aims to integrate into the user-profile additional data that might be retrieved and interpreted from external designated data sources 40, which may be data sources owned by a company using system 8. These data sources can include demographic data as well as behavioral data, such as Call Data Record for telecom users of a telecom company, or user shopping history from e-commerce companies and so on. Data integrator module 14 may then interpret the data to fit into the user-profile-space model (i.e. may place each type of data in the section of the profile associated with that type of data), and to integrate into it. The Data Integrator 14 may add to the user profile new features that can be inferred from the specific additional data sources that might be available for that user. Such features can be treated as “sets” of interests, for example topics of articles the user read, brands of items the user had interaction with, etc. The additional features in the data may also be treated as personality signals which may already exist in the social data itself, for example, a user who had interaction with many sport items. This information will be integrated into the profile in a feature that represents high interaction with sports, as well as adding the specific sport brands the user had interaction with, as sets of interests. Such integration can be automatic or manual by manually mapping features to other signals in the data. The Data Integrator actually enriches the “raw data” by adding more “raw data” and by integrating into the “raw data” more insights.

Data Enhancer Module

The data enhancer module 16 further analyzes the raw data from the Social Data Retriever module 12 by adding additional information to the raw data. This may include, for example adding the genre, rating and publication year of a certain movie, which is indicated as being “liked” in a social network, such as may be Facebook. The additional information may be added from databases 50 external to the SCR system 8, for example, from an external database like TMDB (The Movie DataBase). In similar ways, external databases like Echo Nest may be used to enhance the information about music pieces, Alchemy to interpret web pages, Wikipedia to interpret authors, etc.

Data Translator Module

The data translator module 18 translates/interprets social data to a mathematical structure by passing the enhanced datasets as input through the translation models described below. The output is a user profile which uniquely represents the user's character as derived from the different data sources.

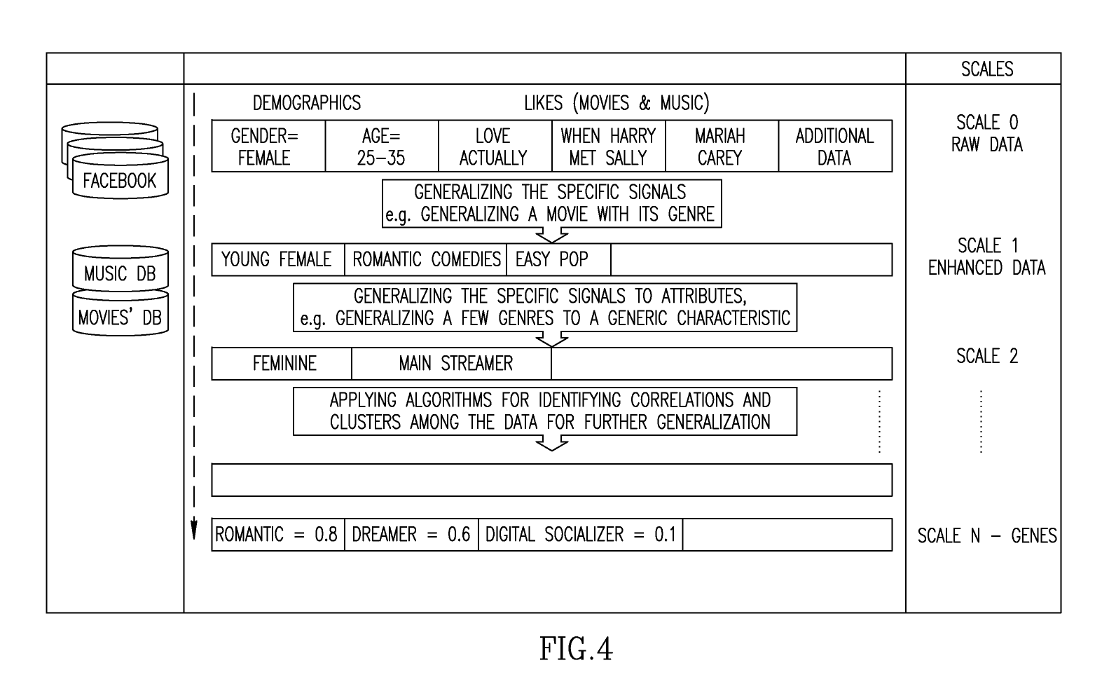

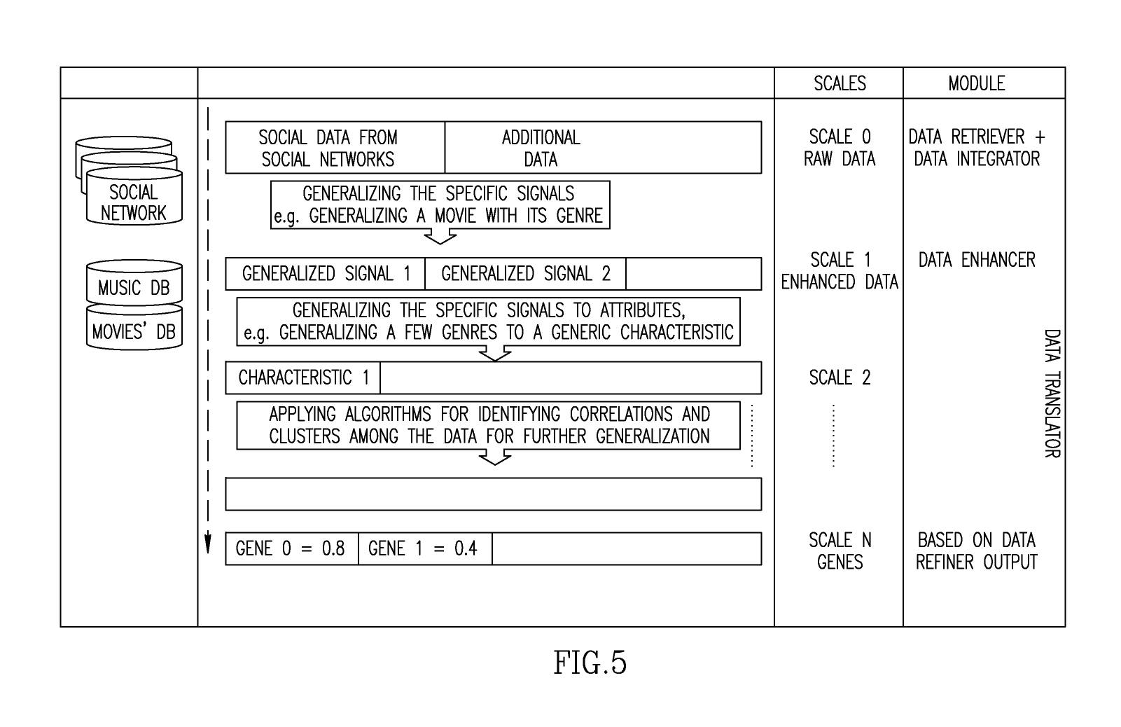

The enhanced social data is translated into data structures in a bottom-up manner, to produce the “User-Profile Space”. The user-profile-space is composed of several “scales” of the data being interpreted. Each scale in the user-profile space represents the user profile in a different level. At the finest scale, the model is very detailed and reflects delicate attributes in the user profile. At the coarsest scale, the model is more general and reflects the user profile in terms of generic attributes that are aggregated along the scales. The topmost level defines the generic attributes of the user, to whom we shall refer as the user's Genes Set. For example, at the finest scale, we can identify a user's like on a certain movie, one scale above, we “smooth” the signal of the specific movie, and instead we look at the genre. If the user liked a few movies from the same genre, in that layer, the signal for that specific genre will be stronger. This is shown in more detail with reference to FIGS. 4 and 5, described in more detail herein below.

Data Analyzer Module

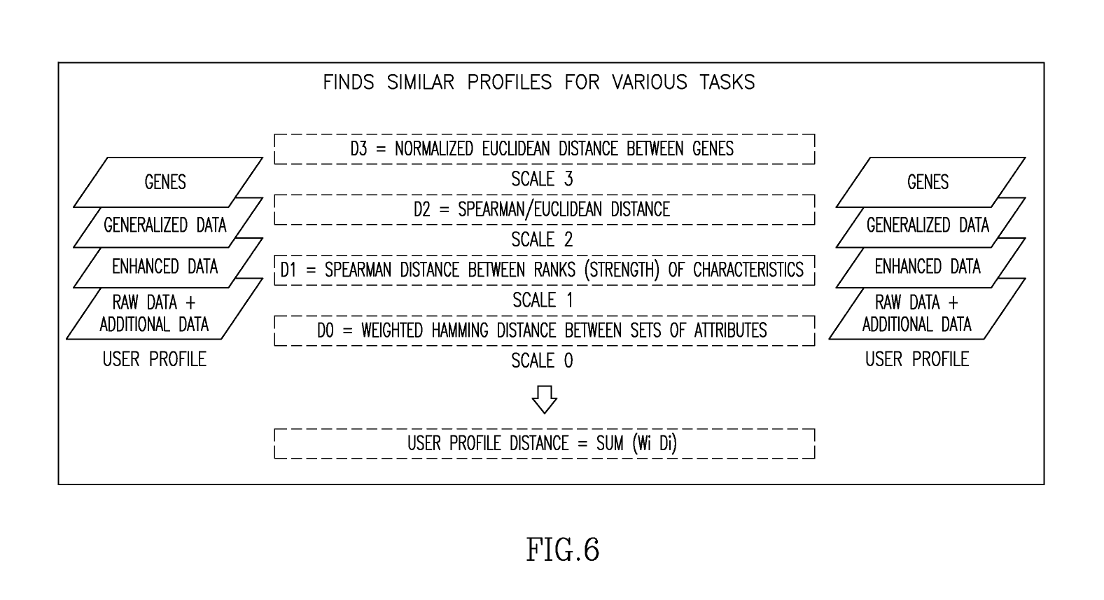

The data analyzer module 30 may use data mining algorithms to analyze the translated data, i.e. the user-profile. The Data Analyzer module 30 wishes to find similarities among user profiles, among items profiles, and among users' and items' profiles. These similarities will later be the input to various tasks the SCR system can perform, such as a recommendation engine 60, an analytic engine 70 and others. The Data Analyzer takes a user and/or item profile space as input, and searches among other profile spaces for similar profiles. As discussed hereinbelow with respect to FIG. 6, the Data Analyzer Module 30 may use different data mining and machine learning algorithms to output either clusters of similar users' profiles/items' profiles, or lists of similar users or items per user/item.

After the first levels of the User Profile Space are constructed, the Pattern Discoverer 22 and the Pattern Refiner 24 may process many profiles to discover the behavioral traits, aka Genes, and may thus complete the construction to the user profile space. The User Profile is then transferred to the Data Analyzer 30 which may analyze the data for providing personalization services such as recommendations and analytics.

FIG. 2 illustrates a use case for the SCR system. The end user browses to a web page or uses a mobile app. Her data is transferred via a front end server to the SCR system 8, which starts to construct the user profile by first retrieving the relevant data from the different data sources, then processing the data and constructing the profile. The profile is then analyzed for the use of the recommendation engines and the analytics engine and for other personalization tasks.

Pattern Discoverer Module

The pattern discoverer module 22 discovers meaningful, influential and/or predictive patterns using user behavior data on a certain website (such as product purchases) as training sets to the machine learning algorithms, in particular, to clustering to decision trees and to SVM (Support Vector Machines). The output may have different meaningful conclusions, such as best classification rules, feature selection, feature groups, user clusters and distribution analysis inside them, etc. all of which may be used to discover hidden patterns in the user profiles collected into the system 8. Such patterns may serve for the detection of attributes that can be aggregated to form more generic attributes, for the discovery of meaningful groups of users that might induce a specific unique characteristic possessed by these users and for the setting of the “mean” genes values in the populations in order to set the strength for each gene.

In addition to such unsupervised insights, pattern discoverer module 22 may also serve for supervised learning. This option is based on a training set that represents a certain required classification or analysis challenge. Algorithms for supervised learning such as decision trees and SVM are also used in order to find good techniques to match similar users and/or items together, which is an important element of various prediction, recommendation, personalization and analytics tasks. This module may also use machine learning and data mining methods such as clustering and association rules to complete missing values on the user-profile, for different learning tasks. Patterns that may be discovered in the data are based on sets of attributes. These attributes may be “projected” on users that have similar patterns, although some of these attributes are missing for them.

Discovery of meaningful, influential and/or predictive patterns: As previously discussed, one of the major challenges is to find combinations of social signals that are influential. Since there are thousands of such signals, the number of possible combinations is endless, and the running time required to measure their influence is unrealistic. The user-profile may comprise a network of relations, in each of the scales. Therefore, pattern discover module 22 may analyze the network of relations, looking for the network's topology, and to detect sub-networks and other patterns, which are sufficient to describe the properties of the whole network, typically by using algorithms such as back propagation and self-organizing feature maps (SOM's). The application of such algorithms in the world of social data enables the inference of similar conclusions in terms of meaningful social patterns that are predictive to other characteristics of social entities.

The generic data mining and machine learning algorithms in this module are designed to work specifically on the user profile. The input to these algorithms is the user-profile-space or one/few scales from the profile, the algorithms are constantly learning which part on which scales of the user profile can be most productive in outputting the most optimized desirable results, given a certain scenario. Such an influential and productive part in the profile is recognized by the Pattern Discoverer, by finding sets of features with high correlation to a certain desired pre-defined property. For example, a certain customer may wish to address a group of users with high interest in sports, or we may find out that users with a certain behavior tend to be more interested in sports; using clustering and decision trees, the Pattern Discoverer may attempt to find sets of features across all available profiles that are highly correlated to sports activity. When searching for similar profiles for producing recommendations, the Data Analyzer will focus on these sets and may ignore/give lower weight to other features when calculating the distances.

Pattern Refiner Module

The pattern refiner module 24 may comprise a man-machine interface which may allow the patterns discovered by the machine to be improved by human experts such as psychologists, anthropologists, sociologists and media analysts, among others. The experts may both tune the results and may provide descriptions of them. For example, a certain combination of social signals may include ‘Top’ as a taste in music, together with a ‘PhD’ as an education level and ‘oriental cities’ as the kind of places traveled in the past year. The experts may decide that this combination reflects a ‘Geeky’ personality, but may also replace ‘Top’ music with ‘Metal’ music, since it may better represent the ‘Geeky’ character. This change may influence the predictive power of the pattern found by pattern discoverer 22, for better or for worse, but it may also influence the robustness of the prediction among new kinds of future datasets. The benefits of this human analysis are that by understanding the true nature of real personalities of human beings, they may improve predictive power and robustness, in cases where algorithms fail. Another important benefit is the naming and the description of those patterns in terms of personality traits (such as Geeky, Hipster, Creative, Melancholic and so on). These may be exposed as one of the outputs of the SCR system.

Creating Item Profile by Single and Multiple User Infections:

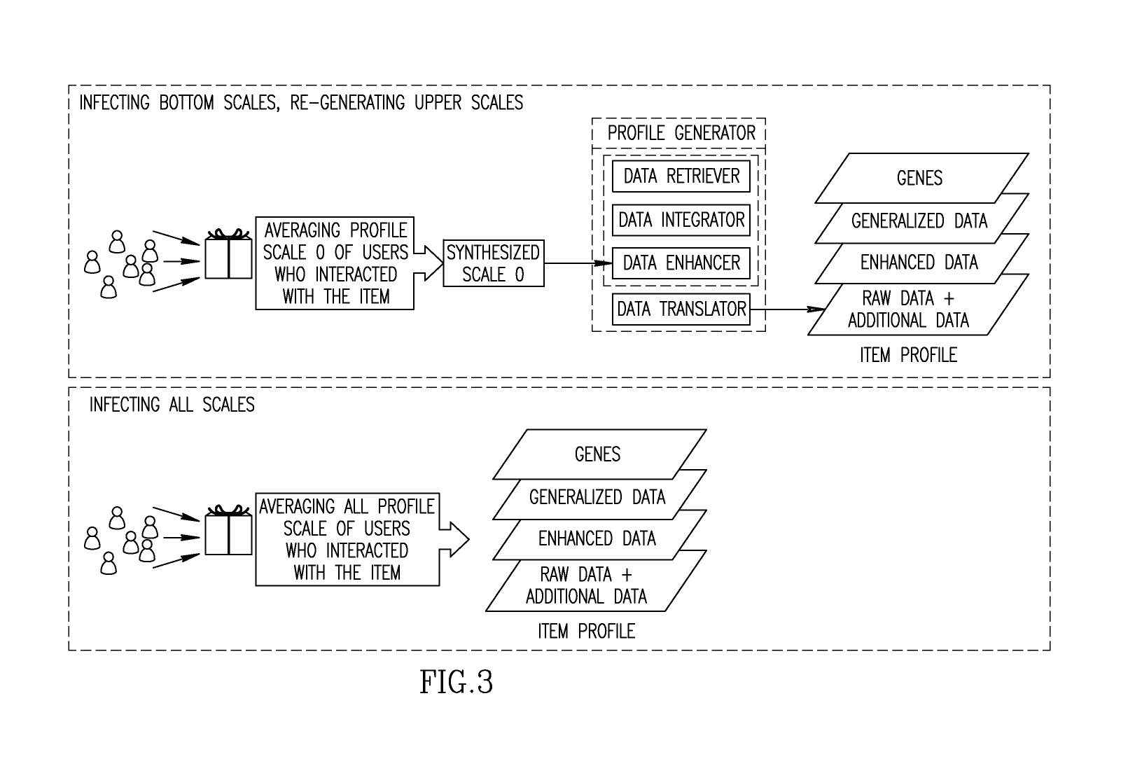

Reference is now made to FIG. 3, which illustrates the process of infecting an item with users' profiles. As previously described, the social profile of a user may be expressed by a mathematical model, the User Profile Space. It will be appreciated that, in the same way that a user may be defined by these representations, a web-item may also be defined (in an “infection” process). For example, the user profiles of users who purchased a certain eCommerce product may be assigned to that product by averaging one or more scales from the users' profiles, which results in synthesized scales which are sent as input to the SCR System 8, for items rather than for users. Therefore, the item's assigned profile represents the characteristics of the users who have a high affinity to it. If multiple users with different profiles purchased (and infected) the same item, the item's assigned profile may be calculated as the average of all infected profiles. Such an averaging process can be done on each of the scales in the item/user profile for creating the item profile space, or by averaging one/a few scales and then generating the rest of the scales in a similar manner to that performed by the Data Translator. The benefit in doing so is that the final item profile may be more accurate as it being built based on a synthesized “raw data”.

The creation of the item profile is done by a weighted averaging of the user profiles that had interactions on the web-item, or by using different data mining algorithms, such as clustering and decision trees, to identify highly significant characteristics of users how had interactions with that specific web-item. Once such characteristics are identified and verified, they may be projected onto the item profile which is in the same structure as the user profile. The item-profile may be constantly refined as more users have interactions with this item.

To this end and as shown in FIG. 2, a website may have an SCR client 100, which may interact with the SCR 8 and may receive the associated user profile of the users who interacted with it.

Complex User Infections: In many cases, the averaging process mentioned in the previous section cannot reflect the diversity of individuals who have high affinity to a certain web-item. For example, if 45% of the people who infected an item are extremely optimistic, 45% percent of them are extremely pessimistic and only 10% are optimistic exactly as they are pessimistic, the average won't reflect this distribution. On the contrary, the average will reflect that this item has the highest affinity to users who are optimistic exactly as they are pessimistic, while in reality this is true in only 10% of the cases. In the other 90% of the cases, users who are at the extreme ends (either pessimistic or optimistic), and in reality have high affinity to the item, will not be considered as such. This problem may be solved when using advanced mathematical data structures and algorithms that may better analyze the multi-modal distribution of characteristics of several scales as expressed in the User Profile Space, as follows:

Attributing User Profile to Items (Infection)

Step 1. A user logs into a website while using her “social sign-in”, which is a service provided by different social networks to identify a user in a website according to his social profile (e.g., the Facebook-Connect service for Facebook profile).

Step 2. The SCR system retrieves the raw social data, enhances it and detects the social genes of the user.

Step 3. The user browses through the website's pages or items, buys some of them, shares some of them with his friends, etc. By doing so the genes of the user are virtually added (“infected”) into the metadata of the website's pages or item, which the user browsed, bought, shared, etc. The level of infection may differ per the type of each action (buying is stronger than browsing).

Step 4. The above is true for all the users who browse the site and for whom the SCR has their gene data (those who used the social sign-in). Therefore, genes from different sources (users) may be infected into a single web-item. These user profiles will be assembled together, one on top of the others, in a statistical representation that quantifies their homogeneity and diversity.

Recommending Items to Users According to Item/User Association:

The recommendation engine 60 determines similarities among users'/items' profiles as they are inferred from the data collected from social networks, external data sources and the processing of the SCR system. The recommendations can be based on the following similarities:

User-User Similarity

In order to give recommendations to a specific user, a profile is created for that user. Then, recommendation engine 60 searches a user profiles database, forming part of pattern discoverer 22, for similar profiles (as described in Data Analyzer Module). Such a search yields a list of candidate profiles which generally reflect the same preferences and interests of the specific user. Each candidate is given a “score” to note how similar this user is to the specific user. After thresholding the candidates list, recommendation engine 60 has a smaller list of the most similar users. Recommendation engine 60 then searches for their extra preferences and extra items they might have had interaction with. Recommendation engine 60 weights each of these additional items with respect to pre-defined parameters and constraints. These constraints might come as a demand from a company using system 8, or as predefined rules. Such constraints may be for example: A very unique item that appears in many candidates but does not appear with high probability in the total population will be promoted, or, during the holidays, give recommendations only from a specific set of items, or for a user that is identified as sporty give sport products from a certain brand, and so on.

User-Item Similarity

If no sufficient candidates can be found for a certain user, recommendation engine 60 may base the recommendations on a User-Item Similarity. As both users and items have a user profile with the same mathematical representation, recommendation engine 60 can search for candidate items that are similar to the specific user. Such a search yields a list of candidate items, which are weighted according to pre-defined parameters and constraints (as mentioned above) and recommended accordingly.

Item-Item Similarity

Another way that recommendation engine 60 gives recommendations is by finding similarities among items' profiles. A user may already have a history in the web site/mobile app, i.e. there's exists a list of items with which the user has had an interaction. These items can imply the user's preferences. The recommendation engine 60 may analyzer unique items in the users' item list, and for each of the items, it may search the items' profiles for similar items (i.e. having similar profiles). Such a search yields a list of candidate items per each of the items the user had interaction with. After applying a threshold on the list of items, the recommendation engine 60 may weight the remaining candidate items according to pre-defined parameters and constraints (as mention above) and are given as recommendations to the user in concern.

Following is a step-by-step Recommendation process:

Step 1. A new user logs into a website and the web-service provider wants to offer him recommended items. As previously described, his social data will be retrieved, enhanced and analyzed by the SCR system 8 to produce his user profile.

Step 2. Since items in the websites also user profile, due to the infection process mentioned above, the statistical similarity between the profile of the user and the profiles of each of the items in the website (or in an internal search result), will be quantified by the SCR system 8, and typically by recommendation engine 60.

Step 3. The items whose user profile is most similar to the user profile of the user will be displayed as recommendations.

An alternative to step 2 above would be to use other recommendation algorithms, such as “collaborative filtering”, but based on the profiles created by the SCR. As an example, Step 2 would be replaced by the following steps, 2A-2D:

Step 2A. For example: the statistical similarity may be quantified between the user profile of the user to the user profile of other users in the web site (not as in step 2, that it was to the user profiles of items).

Step 2B. A group of the most similar users may be defined, according to the number of users in the group or the similarity distance from the original users.

Step 2C. All the items that the users in this group have previously selected in the website (browsed, purchased, shared, etc.) may be listed.

Step 2D. Recommendations may be given to the original user according to how common each of the items is in the above-mentioned list. For example, the top 5 most common items may be presented.

FIG. 4 illustrates the construction of the User Profile Space by the different modules, orchestrated by the Data Translator Module. The first scale, scale 0, is the raw data that is retrieved from the different social networks and from different designated data sources and is created by the data retriever 12 and the data integrator 14. The next scale, scale 1, is constructed by the Data Enhancer Module 16 which enriches the data by providing additional content and interpretations to the raw data. The next scale, scale 2, aggregates similar/correlated traits to more generic attributes and is enriched and enhanced by the Data Enhancer and finalized and added to the user profile space by the Data Translator 16. The topmost scale is the social character which express the personality and character of the user profile in a generic and conventional manner and is created after taking the input from the pattern discoverer and the pattern refiner.

FIG. 5 provides an example of the construction of an exemplary User Profile Space. Starting at scale 0—the raw data, which may include different movies the user liked, different music or artists the user followed and so on, where each section of the user profile is designated for different types of data. The next scale shows the interpretation of the previous scale by aggregating together all movies from the same genre and giving a score to that genre that expresses how well the user interacted with this specific genre. The next scale shows a higher view of the traits expressed on the previous scale and so on. The top most scale shows the Genes and their level as inferred from the previous scales.

Measure Similarity between Profiles.

Reference is now made to FIG. 6 which illustrates the similarity calculations done by the Data Analyzer 30.

Before we can measure similarities between the profiles, some pre-processing work should be done on the profiles. Such pre-processing may include smoothing of some of the signals to reduce noise and normalizing values so they are comparable. Each of the profiles being measured will be pre-processed.

As the data may contain noise that should be ignored, but on the same time should be sensitive to delicate signals in the user profile, measuring distance using standard methods may not yield the desirable results. The user-profile-space addresses this problem, by “holding” the data in the different scales. At the top-most level, the signals are smoothed and the existence of noise is minor; while at the bottom levels, the data is very detailed, so specific unique characteristics are expressed. The Data Analyzer 30 may measure the distance at each scale, and may weight the distance measurements per scale accordingly (bottom-level similarities have larger weight), so as a result, a true measure of the distance between users can be evaluated.

The similarity between the profiles is first calculated in each scale. This approach allows us to utilize the different “views” the scales represent to assess the distance between the profiles, based on the results inferred on each scale. Obviously, a smaller distance at a lower level means a stronger similarity between the profiles, whereas a smaller distance at a coarser scale means a general similarity between the profiles.

In each scale, Data Analyzer 30 may apply different measuring methods and different metrics, with respect to the data that resides in each scale. In the bottom most scale, where the raw data lies, Data Analyzer 30 may consider the detailed features (e.g. movies the user liked, artists the user followed etc.) as sets of preferences, divided to categories. So, Data Analyzer 30 may produce a scale 0 distance D0 using metrics such as the Hamming distance or the Jaccard similarity measure to determine the distance/similarity between each set in each of the categories. Data Analyzer 30 may then weight the scores per each category, and may compute the total similarity D0 between the profiles for that scale.

On the next scale, scale 1, where the data is enhanced, yet manifests a higher level of the attributes of the previous layer, Data Analyzer 30 may treat each attribute as an ordered number. For example, when the user likes different movies which are all from the same genre, Data Analyzer 30 may score that genre in accordance to the amount of the “likes” the user gave. To calculate the similarities between these scores, Data Analyzer 30 may use metrics, such as Spearman distance, to determine the distance D1 for scale 1.

Similar computations are performed on the next scales, where Data Analyzer 30 may use a combination of a Spearman Distance with a Euclidean Distance for scale 2 and a Normalized Euclidean distance for scale 3, the gene level

After completing this process, Data Analyzer 30 may generate, for each pair of profiles, a similarity score per scale. Data Analyzer 30 may weight these scores together, taking into account the scale the measure was computed on, as the lower the level is, the higher the weight Wi that Data Analyzer 30 may provide it for computing similarity. Thus, the user profile distance may be Sum (Wi*Di).

It will be appreciated that the User Profile Space takes into account both specific traits in a user's personality as well as generic attributes. Moreover, its construction in scales ensures that all of a user's personality traits are taken into account to some extent. Since each scale is weighted in accordance with the specification level within that scale, the representation of the users' personality best suits the tasks that the SCR system 8 performs. This is useful for finding similar profiles—2 profiles that are said to have a small distance between them are verified to represent very similar personalities, whereas 2 profiles that are said to have a large distance are verified to represent 2 different personalities with different preferences, behavior and so on. This important property enables us to best find similarities between profiles, a task that lies at the core of the recommendation engine and analytics services.

Invariant to Noise:

Social data is known to contain a lot of noise which is usually hard to identify, since some of the signals that may considered as being noisy for one task may be crucial to another. The user profile descriptor may be generally invariant to noise since it constructs each scale by smoothing the previous scale. The bottom-most scale is in high resolution on one hand, but might also include noisy details. For example, a user might have liked one movie from a certain genre, but she has no other indications that might imply any association to that movie's genre. This specific movie is expressed in scale 0, but actually, when taking into account the entire personality this may say very little about the user's personality. In the next scale, when instead of movie, we look at the genre; we will “score” this genre with a very low score as no other indications for that genre appeared in the previous scale. In the next level, where a few genres are aggregated to a personal characteristic, this specific movie will hardly have any effect. This way of smoothing ensures that the final descriptor will reflect the signals in the raw data with the appropriate weight and will smooth any signals that might be interpreted as noise.

Sensitive to Nuances:

As much as smoothing is an important task when creating the user profile, we still want the user profile descriptor to be able to express nuances in the user's personality as this should make the recommendations given to the user and the analytics performed on a group of users more accurate and give added value over other recommendations engines/analytic services. Once a user profile space is constructed, the system may perform tasks such as finding similar profiles, clustering profiles according to some pronounced features and so on. This is done by calculating distances/similarities among profiles as described hereinabove in the description of the Data Analyzer 30. The final distance/similarity between profiles is calculated in each scale separately, and then each distance is weighted according to the level of accuracy this scale represents, for example, a high similarity in scale 0 even of a sub set of the features may mean a very high similarity in the users' preferences (e.g. they liked the same movies and not just genres). The unique way these distances/similarities are calculated ensures that even the slightest nuance in the user profile is taken into account. Of course a good balance should be made between what is defined as noise and what is defined as nuance and this is done by the different weights set for each scale in the distance calculation.

“Adaptive” User Profile

Another important property of the above user profile descriptor is its “Adaptivity”. As one might expect, a user may be active in the social networks and on a specific web site/mobile app even after such a social profile was created for her. As long as the user is in system 8, system 8 may regularly update/re-create the user's profile, by re-activating the process for creating the user profile.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

What is claimed is:

1. A social character recognition system comprising:
a user profile constructer to generate a user profile from user's social information available on the internet and from other external information, said user profile having multiple scales, where the lowest scale comprises the raw data, higher scales aggregate the data into generic attributes and the topmost level defines a social character of said user; and
a data analyzer to calculate similarities at least between a first user profile and a second user profile based on weighted functions of distances between said each of said scales in said user profiles.

2. The social character recognition system according to claim 1 and wherein said user profile constructer comprises a data retriever to retrieve user social information from a user's social networks and other databases which describe a user's interests and actions, wherein said user social information comprises at least one of: demographics, media items the user shared or ‘Liked’, posted texts and photos, groups to which s/he belongs, events s/he went to, places in the world s/he visited or ‘checked-in’, schools s/he attended, relationships dynamics with their friends, and activity properties in social networks.

3. The social character recognition system according to claim 1 and wherein said lowest scale has an associated strongest weight.

4. The social character recognition system according to claim 1 and also comprising a website client to provide a user profile of a user who shows an interest in a product to said product thereby to pass the user profile of said user to said product.

5. The social character recognition system according to claim 1 and also comprising:
a user pattern discoverer to define a plurality of user social characters based on a multiplicity of user profiles,
wherein said data analyzer comprises a social character updater to update a new user profile with a social character given to a user profile found to be similar to said new user profile.

6. The social character recognition system according to claim 1 and wherein said user profile is at least one of: invariant to noise, sensitive to nuances and encapsulates a user's personality traits on many levels.

7. The social character recognition system according to claim 1 and also comprising an infection engine to infect items sold by a company with a user profile of a user who interacted with said items thereby to provide said items with profiles.

8. The social character recognition system according to claim 7 and also comprising a recommendation engine to recommend items to a user based on the similarity of said user's profile with an item's profile.

9. A method for social character recognition, the method comprising:
generating a user profile from user's social information available on the internet and from other external information, said user profile having multiple scales, where the lowest scale comprises the raw data, higher scales aggregate the data into generic attributes and the topmost level defines a social character of said user; and
calculating similarities at least between a first user profile and a second user profile based on weighted functions of distances between said each of said scales in said user profiles.

10. The method according to claim 9 and wherein said generating comprises retrieving user social information from a user's social networks and other databases which describe a user's interests and actions, wherein said user social information comprises at least one of: demographics, media items the user shared or ‘Liked’, posted texts and photos, groups to which s/he belongs, events s/he went to, places in the world s/he visited or ‘checked-in’, schools s/he attended, relationships dynamics with their friends, and activity properties in social networks.

11. The method according to claim 9 and wherein said lowest scale has an associated strongest weight.

12. The method according to claim 9 and also comprising providing a user profile of a user who shows an interest in a product to said product thereby to pass the user profile of said user to said product.

13. The method according to claim 9 and also comprising:
defining a plurality of user social characters based on a multiplicity of user profiles,
wherein said calculating comprises updating a new user profile with a social character given to a user profile found to be similar to said new user profile.

14. The method according to claim 9 and wherein said user profile is at least one of: invariant to noise, sensitive to nuances and encapsulates a user's personality traits on many levels.

15. The method according to claim 9 and also comprising infecting items sold by a company with a user profile of a user who interacted with said items thereby to provide said items with profiles.

16. The method according to claim 9 and also comprising recommending items to a user based on the similarity of said user's profile with an item's profile.
